(19) United States
(12) Patent Application Publication
(10) Pub. No.: US 2009/0259488 A1
(43) Pub. Date: Oct. 15, 2009

(54) VETTING DOCTORS BASED ON RESULTS

(75) Inventors: Alexander Gounares, Kirkland, WA (US); Chris Demetrios Karkanias, Sammamish, WA (US); Kim Cameron, Bellevue, WA (US); Hong Choing, Collegeville, PA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/100,473

(22) Filed: Apr. 10, 2008

(51) Int. Cl. G06Q 50/00; G06Q 10/00

(52) U.S. Cl. 705/3; 705/9; 705/2

(57) ABSTRACT

The claimed subject matter provides systems and/or methods that identify healthcare professionals appropriate to treat diseases. The system can include mechanisms that employ patient symptoms, diagnoses associated with the symptoms, proposed treatment plans, or treatment outcomes based on proposed treatment plans, to construct and utilize dependency graphs to infer a score. The inferred score can then be employed to identify qualified healthcare professionals appropriate to treat the disease as presented by the patient and indicated by the symptoms.

### BACKGROUND

Attempting to find an appropriate physician capable of treating ones ailments and ills can be a frustrating process. Current methods of identifying physicians has been confined to brute force searching, such as utilizing search engines, telephone directories, word of mouth, insurance carrier requirements, or family or acquaintance suggestion/recommendation, to list but a few. Further, current methods of identifying physicians have only had a local context (e.g., within a particular, city, state, or region) rather than a global scope (e.g., continent wide, world wide). None of the foregoing has been able to satisfactorily match presentation of a patient's symptoms with the most qualified physicians or medical care regardless of location.

There nevertheless exist vast repositories of information with regard to diseases, physicians, diagnoses, treatments, and outcomes. For example, the Internet can provide much information regarding diseases, diagnoses, and treatments. Further, many hospital databases, if they can be accessed, can also provide an abundance of information related to physicians, sicknesses, infections, contagions, treatments, and treatment success or failure rates. Moreover, many governmental, professional and charitable organizations, foundations, and self-help organizations (e.g., American Medical Association, Royal College of Surgeons, World Health Organization, American Cancer Society, Canadian Diabetes Association, National Institutes of Health, Heart and Lung Foundation, and the like) also persist information related to symptoms, prognoses, treatments, clinical studies being undertaken, and physicians that practice in particular areas of specialty.

Nevertheless, despite the surfeit of information that is clearly available and easily accessible, it can be difficult to find qualified healthcare professionals to treat afflictions of a prosaic nature, but it can become combinatorially more arduous to identify appropriate physicians or healthcare professionals to successfully treat syndromes, illnesses and indispositions that have obscure or complex symptomatologies. Accordingly, the subject matter as claimed is directed toward resolving or at the very least mitigating, one or all the problems elucidated above.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

The claimed subject matter in accordance with an illustrative aspect provides a secure system that can track experience and aggregate health information in a centralized location. The information can typically be processed to assist patients, physicians, or teams of physicians make informed decision regarding the patient's health care. For instance, in accordance with an illustrative example, a system can collect and track information that describes success rates for treatments performed by individual doctors, teams of doctors, or particular hospitals. When a doctor, team of doctors, or particular hospital perform a particular treatment, the results of such treatment can be stored, and the system can produce or generate data models than can quantify or rank the reputation of each doctor, team of doctors, or a particular hospital based on the treatment outcomes. The modeled reputation or ranking data can be utilized to help patients identify the most reputable procedures and doctors. This kind of system can be helpful in scenarios when patients see, for example, three doctors who have three different treatment proposals (e.g., surgery, rehabilitation, rest and prescription). Such systems would allow patients to anonymously access accurate medical data that is truly based in the success of failure of a particular doctor or procedure.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a machine-implemented system that identifies healthcare professionals appropriate to treat a disease in accordance with an aspect of the claimed subject matter.

FIG. 2 provides a more detailed depiction of an illustrative matching component that identifies healthcare professionals appropriate to treat a disease in accordance with an aspect of the claimed subject matter.

FIG. 3 provides depiction of a machine implemented system that identifies healthcare professionals appropriate to treat a disease in accordance with an aspect of the claimed subject matter.

FIG. 4 illustrates a system implemented on a machine that identifies healthcare professionals appropriate to treat a disease in accordance with an aspect of the claimed subject matter.

FIG. 5 provides a further depiction of a machine implemented system that identifies healthcare professionals appropriate to treat a disease in accordance with an aspect of the claimed subject matter.

FIG. 6 illustrates yet another aspect of the machine implemented system that identifies healthcare professionals appropriate to treat a disease in accordance with an aspect of the claimed subject matter.

FIG. 7 depicts a further illustrative aspect of the machine implemented system that identifies healthcare professionals appropriate to treat a disease in accordance with an aspect of the claimed subject matter.

FIG. 8 illustrates another illustrative aspect of a system implemented on a machine that identifies healthcare professionals appropriate to treat a disease in accordance with an aspect of the claimed subject matter.

FIG. 9 a flow diagram of a machine implemented methodology that identifies healthcare professionals appropriate to treat a disease in accordance with an aspect of the claimed subject matter.

FIG. 10 a flow diagram of a machine implemented methodology that identifies healthcare professionals appropriate to treat a disease in accordance with an aspect of the claimed subject matter.

FIG. 11 illustrates a flow diagram of a machine implemented methodology that identifies healthcare professionals appropriate to treat a disease in accordance with an aspect of the claimed subject matter.

FIG. 12 provides depiction of an illustrative directed acyclic graph that can be constructed and utilized in accordance with and by an aspect of the claimed subject matter

FIG. 13 illustrates a block diagram of a computer operable to execute the disclosed system in accordance with an aspect of the claimed subject matter.

FIG. 14 illustrates a schematic block diagram of an illustrative computing environment for processing the disclosed architecture in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

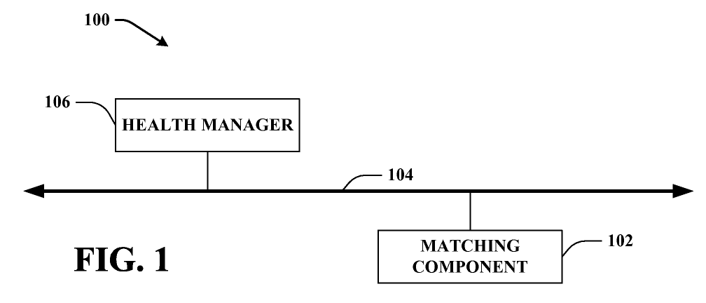

FIG. 1 illustrates a machine implemented system 100 that facilitates and/or effectuates vetting doctors or physicians according to results. System 100 in accordance with an illustrative aspect includes matching component 102 that accesses or acquires data (e.g., symptoms) associated with patients, possible diagnoses associated with the accessed or acquired patient data, available treatment regimes based on the possible and/or suggested diagnoses, outcomes associated with the possible and/or suggested treatments, and physician details (e.g., specialties, number of years in the specialty, etc.). Matching component 102 can utilize received or obtained information to generate matches between patients and doctors thus allowing patients to determine who the appropriate physician (or team of healthcare professionals, or hospitals) should be based on expertise (or lack thereof) in a particular area of medicine. For instance, if a patient presents with a fractured tibia, it would be a waste of a precious resource to direct the head of the nephrology department to set the fracture. Similarly, where the patient presents with hemorrhagic fever (e.g., dengue) it could be fatal for the patient to request an inexperienced first year intern to deal with the situation. Accordingly, matching component 102 can allow patients or prospective patients to find healthcare professionals suited to their particular ailments and healthcare professionals to be assigned to patient illnesses according to the healthcare professional's level of expertise.

Matching component 102 in accordance with an aspect of the claimed subject matter can identify and track patient details and physician or healthcare professional outcomes in order to match the patient with the appropriate physician based at least in part, for example, on the complexity of the symptoms presented and/or the level expertise and specialty of the healthcare professional. Matching component 102 in accordance with a further aspect of the matter as claimed can rank patient symptoms and physician outcomes based at least in part on treatment regimens proposed by and typically associated with particular physicians. For example, for a particular ailment three physicians may proffer three disparate but valid courses of treatment (e.g., let the ailment run its course; prescribe a course of antibiotics; or prescribe bed rest, acetaminophen and vitamin C). Matching component 102 can in this instance rank the physicians based at least in part on the efficacy of their treatment plans (e.g., which treatment plan caused the patient to recover in the shortest amount of time).

As illustrated, matching component 102 can be in continuous and/or operative, or intermittent but sporadic communication with health manager 106 via network topology and/or cloud 104. Matching component 102 can be implemented entirely in hardware and/or a combination of hardware and/or software in execution. Further, matching component 102 can be incorporated within and/or associated with other compatible components. Moreover, matching component 102 can be any type of machine that includes a processor and/or is capable of effective communication with network topology and/or cloud 104. Illustrative machines that can comprise matching component 102 can include cell phones, smart phones, laptop computers, notebook computers, Tablet PCs, consumer and/or industrial devices and/or appliances, hand-held devices, personal digital assistants, server class machines and/or computing devices and/or databases, multimedia Internet enabled mobile phones, multimedia players, automotive components, avionics components, and the like.

Network topology and/or cloud 104 can include any viable communication and/or broadcast technology, for example, wired and/or wireless modalities and/or technologies can be utilized to effectuate the claimed subject matter. Moreover, network topology and/or cloud 104 can include utilization of Personal Area Networks (PANs), Local Area Networks (LANs), Campus Area Networks (CANs), Metropolitan Area Networks (MANs), extranets, intranets, the Internet, Wide Area Networks (WANs)—both centralized and/or distributed—and/or any combination, permutation, and/or aggregation thereof. Additionally, network topology and/or cloud 104 can include or encompass communications or data interchange utilizing Near-Field Communications (NFC) and/or communications utilizing electrical conductance of the human skin, for example.

Health manager 106 can be an online repository and/or directed search facility that persist or stores an individual's health data ranging from test results to physicians reports to daily measurements of weight or blood pressure. Individuals can then have full access to their records at any time, anywhere, via network topology and/or cloud 104. Affiliated medical practitioners, medical offices, and/or hospitals can, for instance, easily forward test results in digital form to health manager 106, and individuals (e.g., patients) can in turn authorize selected medical practitioners, medical offices, hospitals, components owned or controlled by the individual (e.g., matching component 102), and the like, to access various carefully circumscribed aspects of their personal data (e.g., the circumscription of aspects of personal data can be effectuated and/or facilitated through utilization of one or more cryptographic schemes and/or devices). Additionally and/or alternatively, health manager 106 can also provide directed and/or targeted vertical search capabilities that can provide more relevant results than generalist search engines. For instance, a search actuated on health manager 106 can allow individuals to specifically tailor their search queries based on their persisted health records, past queries, and the like, and can receive in return results that are most relevant to each individual's situation. Health manager 106, like matching component 102, can be implemented entirely in hardware and/or as a combination of hardware and/or software in execution. Further, health manager 106 can be any type of engine, machine, instrument of conversion, or mode of production that includes a processor and/or is capable of effective and/or operative communication with network topology and/or cloud 104. Illustrative instruments of conversion, modes of production, engines, mechanisms, devices, and/or machinery that can comprise and/or embody health manager 106 can include desktop computers, server class computing devices and/or databases, cell phones, smart phones, laptop computers, notebook computers, Tablet PCs, consumer and/or industrial devices and/or appliances and/or processes, hand-held devices, personal digital assistants, multimedia Internet enabled mobile phones, multimedia players, and the like.

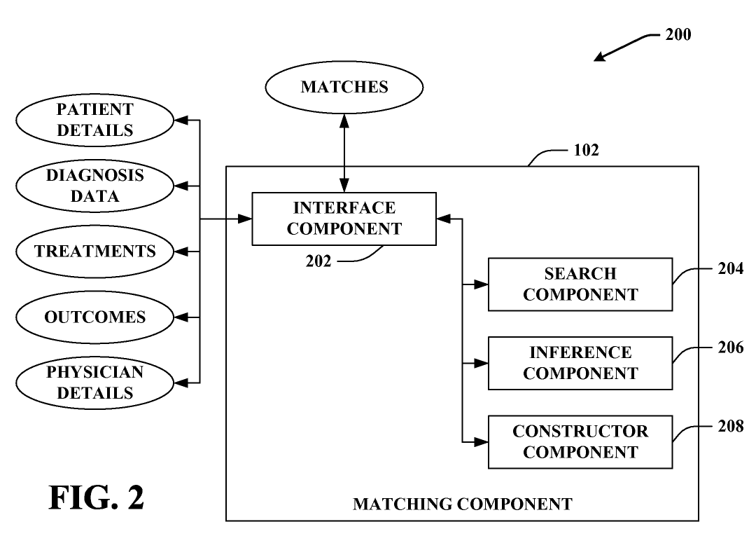

FIG. 2 provides further illustration of matching component 102 in accordance with an aspect of the claimed subject matter. As illustrated matching component 102 can include interface component 202 (hereinafter referred to as “interface 202”) that can actively and/or passively acquire or access input, such as, for example, input associated with patient symptoms, diagnoses information, possible treatment options to cure the set of symptoms presented by the patient, probable outcomes of each of the possible treatment options, and physician information, and thereafter output matches between patients and healthcare professionals in the form of a fitness score (e.g., appropriateness of the match between the patient and the healthcare professional), for example. Interface 202 can receive and/or disseminate, communicate and/or partake in data interchange with a plurality of disparate sources and/or components. For instance, interface 202 can receive and/or transmit data from, or to, a multitude of sources, such as, for example, data associated with health records obtained from health manager 106. Additionally and/or alternatively, interface 202 can obtain and/or receive data associated with usernames and/or passwords, sets of encryption and/or decryption keys, client applications, services, users, clients, devices, and/or entities involved with a particular transaction, portions of transactions, and thereafter can convey the received and/or otherwise acquired information to one or more of search component 204, inference component 206, and/or constructor component 208 for subsequent utilization, processing, and/or analysis. To facilitate its objectives, interface 202 can provide various adapters, connectors, channels, communication pathways, etc. to integrate the various components included in system 200 into virtually any operating system and/or database system and/or with one another. Additionally and/or alternatively, interface 202 can provide various adapters, connectors, channels, communication modalities, and the like, that can provide for interaction with the various components that can comprise system 200, and/or any other component (external and/or internal), data, and the like, associated with system 200.

Matching component 102 can further include search component 204 that can utilize patient details or diagnosis data, to identify or surface data persisted throughout the network topology and/or cloud 104 (e.g., utilizing hospital databases, the Internet, databases associated with various professional organizations and/or foundations, etc.) and pertinent to patient details and/or diagnostic data. For example, if the patient presents with symptoms indicating esthesioneuroblastoma, search component 204 can data mine disparate cancer websites, to locate information regarding treatment options, physicians or healthcare professionals capable of conducting or carrying out the identified treatment options, and outcomes for each of the treatment option and associated with each physician or health care professional providing the treatment option. Additionally and/or alternatively, search component 204 can cause health manager 106 to employ its vertical and/or more directed search capabilities to also conduct searches though its repositories of persisted information. Moreover, search component 204 in order to provide effective searches in what can be a morass of conflicting detail, can deconstruct or decompose the patient's queries, through utilization of machine learning or artificial intelligence, in order to better identify what it is that the patient is seeking given a set of characteristics with information that is currently available.

Matching component 102 can also include inference component 206 that can infer prototypical attributes about the presenting individual (e.g., patient) and his or her ailments. Similarly, inference component 206 can make inferences with regard to healthcare professionals based at least in part on board certifications in specialist medical areas (e.g., obstetrics and gynecology, dermatology, oncology, and the like), number of year of practice in the specialty or number of years since graduation from medical school, paper authored, etc. Inference component 206 can utilize these various pieces of information to assign an average skill level to a particular disease or specialty. For instance, the average skill level needed to diagnose and treat a bone fracture or diagnose a sprained ankle can be fairly low, whereas the skill level necessary to correctly diagnose and successfully treat esthesioneuroblastoma can be accordingly high.

Moreover, inference engine 206 can also utilize an uncertainty or belief level associated with the healthcare professional's skill in treating a particular syndrome or ailment. The uncertainty or belief level in conjunction with the perceived average skill necessary to treat a particular disease can be used by inference component 206 to maintain a belief in every healthcare professional's skill. Thus, if the uncertainty level associated with the healthcare professional's is high it is an indication that inference component 206 does not know exactly the skill level to attribute to the healthcare professional (e.g., the physician may be new to the system). Conversely, where inference component 206 ascertains that the uncertainty level associated with the healthcare professional is low or small, it can be an indication that inference component 206 has a strong belief that the healthcare professional's skill level is close to the average skill required within a particular medical specialty. In accordance with an aspect of the matter claimed therefore, inference component 206 can utilize a bell-curve belief distribution (e.g., Gaussian distribution) to rank or rate a healthcare professional's skill in a particular area of medicine. For example, a cardio-thoracic surgeon can be ranked or rated much above average in the context of heart bypass surgery, but nevertheless ranked as being significantly below average in the area of diagnosing and treating bone fractures. Similarly, a nurse practitioner can be ranked well above average in the context of setting bone fractures and below average in the context of treating drug resistant tuberculosis.

Nevertheless, despite the ratings or rankings associated with healthcare professionals at any instance in time, it is to be understood that the average skill associated with a particular medical area specialty can be dynamic in the sense that the level of skill required to diagnose and treat an ailment may become more elementary over time and as the ailment become better understood. For example, prior to the introduction of antibiotics a high level of skill was required to diagnose and treat leprosy, subsequent to the introduction of antibiotics diagnosis and treatment of leprosy is fairly routine and easily curable. Conversely, an area that has been rated as requiring a low skill level can be significantly upgraded where, to continue the foregoing example, the disease presented becomes drug resistant (e.g., leprosy, tuberculosis, streptococcus A—necrotizing fasciitis, . . . ) and/or commensurately less well understood. It should further be appreciated, that the ranking and rating inferences made by inference component 206 can also be subject to change during the course of a particular course of treatment. For instance, a patient can initially present with mild flu like symptoms treatable by a first year medical student, but over the course of the prescribed treatment regimen it may become apparent that the mild innocuous flu like symptoms, through misdiagnosis, lack of experience, or due other complications or complexities, is now severe acute respiratory syndrome (SARS) that requires a healthcare professional with considerable skill and experience.

A constructor component 208 can also be included with matching component 102. Constructor component 208 can receive ratings or rankings with regard to healthcare professionals and/or patient symptomologies from inference component 206 and/or can further parse patient symptomologies to glean further presenting characteristics/symptoms associated with the patient and the patient's perceived ailment. Additionally and/or alternatively, constructor component 208 can probe health manager 108 to obtain further information affiliated with the presenting patient (e.g., drugs being taken, allergies, previous surgeries, previous ailments, etc.) Moreover, constructor component 208 can utilize search component 204 to identify and suggest alternative treatments and/or healthcare professionals that administer such treatment. With the information gleaned, acquired, or received constructor component 208 can build a neural network or a graphical structure (e.g., directed acyclic graph) in order to determine an appropriate match between a presenting patient and the patient's symptoms and an appropriately qualified healthcare professional capable to treating the patient's symptom in an appropriate manner in a way that accords with the patient's preferred method of treatment. For example, if the patient, having utilized the matter as claimed, has identified three physicians that treat a particular syndrome in three disparate but equally efficacious manners, the patient can prefer one of the three physicians over the other two and can request that the preferred physician attend his or her ailment in the manner in which the physician is particularly skilled.

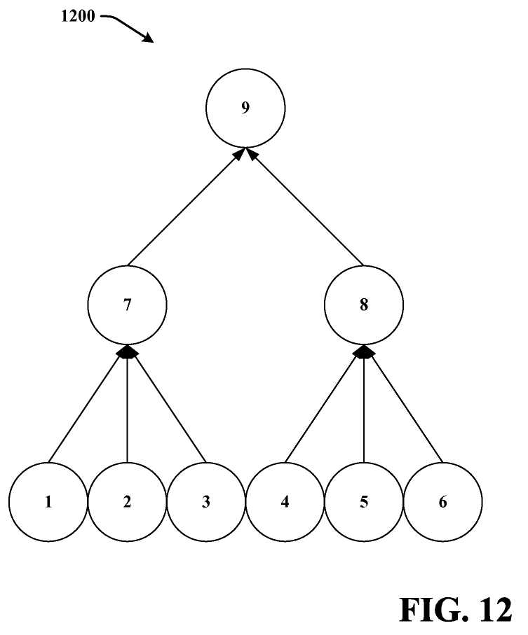

A graph is typically considered to be a structure consisting of nodes that can represent variables and edges between nodes that can represent relationships between the disparate nodes. A directed acyclic graph or dependency graph is generally perceived as being a graph structure with the property that all edges have a direction of connection and no cyclic paths can be found by following the edges in the marked direction. FIG. 12 provides illustration of such a directed acyclic graph 1200 that can be built by constructor component 208 and utilized by inference component 206 in accordance with an aspect of the claimed subject matter. As illustrated directed acyclic graph 1200 can comprise nodes marked 1, 2, 3, 4, 5, 6, 7, 8, 9 where nodes 1, 2, and 3 connect to node 7 via a set of directed edges, nodes 4, 5, and 6 connect to node 8 via another set of directed edges, and nodes 7 and 8 respectively connect to node 9 each via directed edges. Directed acyclic graphs have typically been utilized in modeling many engineering and mathematical tasks. Moreover, it should be noted that it is common notation to refer to nodes that do not have edges coming into them as leaf nodes (e.g., nodes 1, 2, 3, 4, 5, and 6 can be considered leaf nodes). It should be further noted that while leaf nodes typically do not have edges coming into them, leaf nodes can have edges that emanate from them.

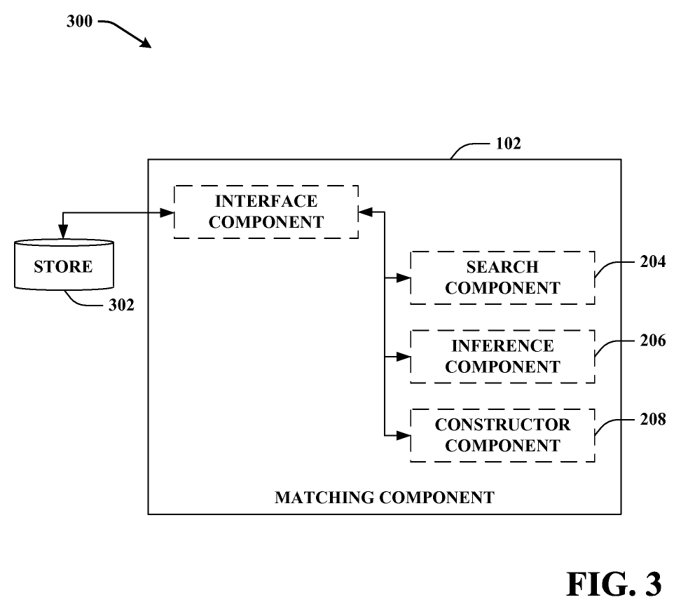

FIG. 3 depicts an aspect of a system 300 that identifies healthcare professionals appropriate to treat a disease in accordance with an aspect of the claimed subject matter. System 300 can include store 302 that can include any suitable data necessary for matching component 102 to facilitate its aims. For instance, store 302 can include information regarding user data, data related to a portion of a transaction, credit information, historic data related to a previous transaction, a portion of data associated with purchasing a good and/or service, a portion of data associated with selling a good and/or service, geographical location, online activity, previous online transactions, activity across disparate networks, activity across a network, credit card verification, membership, duration of membership, communication associated with a network, buddy lists, contacts, questions answered, questions posted, response time for questions, blog data, blog entries, endorsements, items bought, items sold, products on the network, information gleaned from a disparate website, information obtained from the disparate network, ratings from a website, a credit score, geographical location, a donation to charity, or any other information related to software, applications, web conferencing, and/or any suitable data related to transactions, etc.

It is to be appreciated that store 302 can be, for example, volatile memory or non-volatile memory, or can include both volatile and non-volatile memory. By way of illustration, and not limitation, non-volatile memory can include read-only memory (ROM), programmable read only memory (PROM), electrically programmable read only memory (EPROM), electrically erasable programmable read only memory (EEPROM), or flash memory. Volatile memory can include random access memory (RAM), which can act as external cache memory. By way of illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink® DRAM (SLDRAM), Rambus® direct RAM (RDRAM), direct Rambus® dynamic RAM (DRDRAM) and Rambus® dynamic RAM (RDRAM). Store 302 of the subject systems and methods is intended to comprise, without being limited to, these and any other suitable types of memory. In addition, it is to be appreciated that store 302 can be a server, a database, a hard drive, and the like.

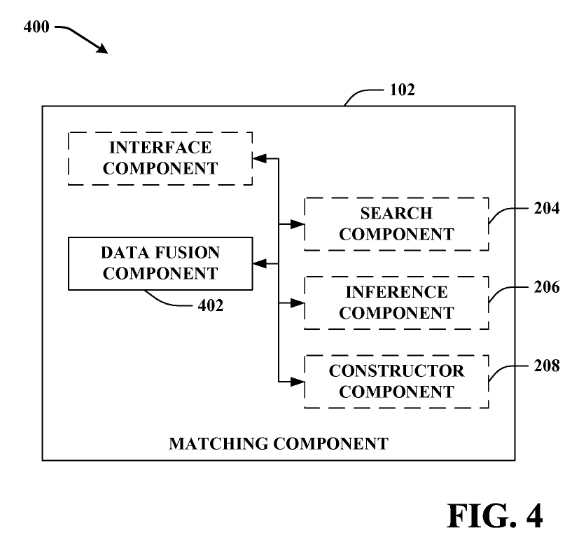

FIG. 4 provides yet a further depiction of a system 400 that identifies healthcare professionals appropriate to treat a disease in accordance with an aspect of the claimed subject matter. As depicted, system 400 can include a data fusion component 402 that can be utilized to take advantage of information fission which may be inherent to a process (e.g., receiving and/or deciphering inputs) relating to analyzing inputs through several different sensing modalities. In particular, one or more available inputs may provide a unique window into a physical environment (e.g., an entity inputting instructions) through several different sensing or input modalities. Because complete details of the phenomena to be observed or analyzed may not be contained within a single sensing/input window, there can be information fragmentation which results from this fission process. These information fragments associated with the various sensing devices may include both independent and dependent components.

The independent components may be used to further fill out (or span) an information space; and the dependent components may be employed in combination to improve quality of common information recognizing that all sensor/input data may be subject to error, and/or noise. In this context, data fusion techniques employed by data fusion component 402 may include algorithmic processing of sensor/input data to compensate for inherent fragmentation of information because particular phenomena may not be observed directly using a single sensing/input modality. Thus, data fusion provides a suitable framework to facilitate condensing, combining, evaluating, and/or interpreting available sensed or received information in the context of a particular application.

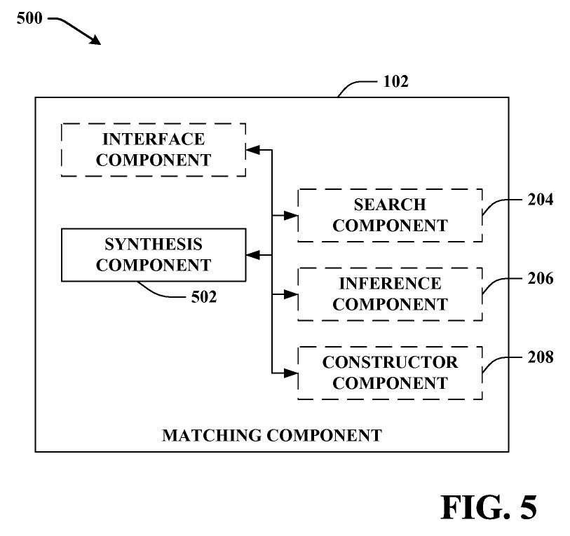

FIG. 5 provides a further depiction of a system 500 that identifies healthcare professionals appropriate to treat a disease in accordance with an aspect of the claimed subject matter. As illustrated matching component 102 can, for example, employ synthesis component 502 to combine, or filter information received from a variety of inputs (e.g., text, speech, gaze, environment, audio, images, gestures, noise, temperature, touch, smell, handwriting, pen strokes, analog signals, digital signals, vibration, motion, altitude, location, GPS, wireless, etc.), in raw or parsed (e.g. processed) form. Synthesis component 502 through combining and filtering can provide a set of information that can be more informative, or accurate (e.g., with respect to an entity's communicative or informational goals) and information from just one or two modalities, for example. As discussed in connection with FIG. 4, the data fusion component 402 can be employed to learn correlations between different data types, and the synthesis component 502 can employ such correlations in connection with combining, or filtering the input data.

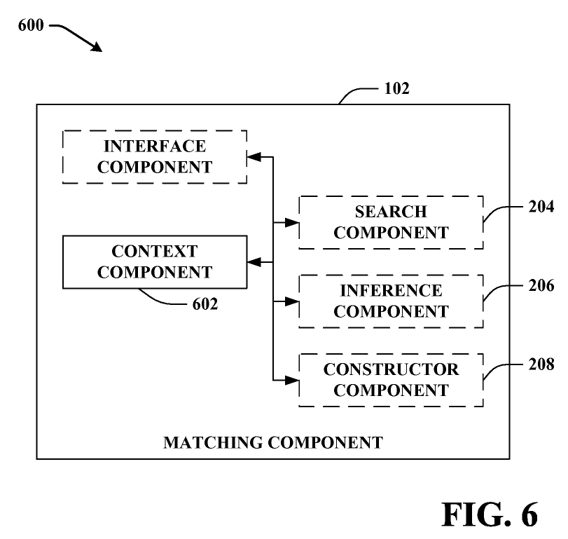

FIG. 6 provides a further illustration of a system 600 that identifies healthcare professionals appropriate to treat a disease in accordance with an aspect of the claimed subject matter. As illustrated matching component 102 can, for example, employ context component 602 to determine context associated with a particular action or set of input data. As can be appreciated, context can play an important role with respect understanding meaning associated with particular sets of input, or intent of an individual or entity. For example, many words or sets of words can have double meanings (e.g., double entendre), and without proper context of use or intent of the words the corresponding meaning can be unclear thus leading to increased probability of error in connection with interpretation or translation thereof. The context component 602 can provide current or historical data in connection with inputs to increase proper interpretation of inputs. For example, time of day may be helpful to understanding an input—in the morning, the word “drink” would likely have a high a probability of being associated with coffee, tea, or juice as compared to being associated with a soft drink or alcoholic beverage during late hours. Context can also assist in interpreting uttered words that sound the same (e.g., steak and, and stake). Knowledge that it is near dinnertime of the user as compared to the user camping would greatly help in recognizing the following spoken words “I need a steak/stake”. Thus, if the context component 602 had knowledge that the user was not camping, and that it was near dinnertime, the utterance would be interpreted as “steak”. On the other hand, if the context component 602 knew (e.g., via GPS system input) that the user recently arrived at a camping ground within a national park; it might more heavily weight the utterance as “stake”.

In view of the foregoing, it is readily apparent that utilization of the context component 602 to consider and analyze extrinsic information can substantially facilitate determining meaning of sets of inputs.

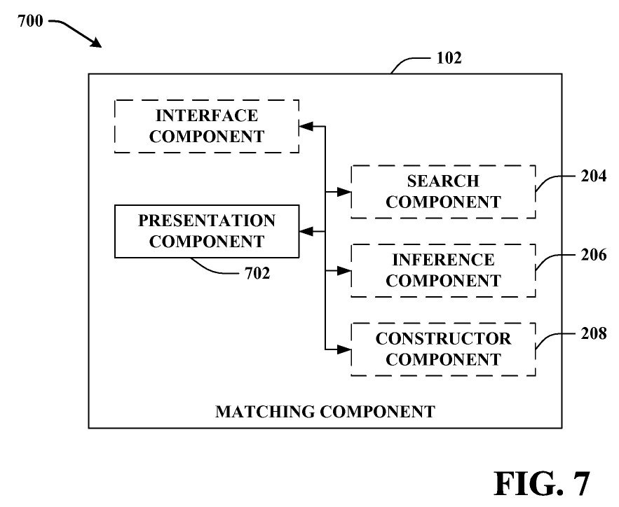

FIG. 7 provides further illustration of a system 700 that identifies healthcare professionals appropriate to treat a disease in accordance with an aspect of the claimed subject matter. As illustrated, system 700 can include presentation component 702 that can provide various types of user interface to facilitate interaction between a user and any component coupled to matching component 102. As illustrated, presentation component 702 can provide one or more graphical user interface, command line interface, and the like. For example, a graphical user interface can be rendered that provides the user with a region or means to load, import, read, etc., data, and can include a region to present the results of such. These regions can comprise known text and/or graphic regions comprising dialog boxes, static controls, drop-down menus, list boxes, pop-up menus, edit controls, combo boxes, radio buttons, check boxes, push buttons, and graphic boxes. In addition, utilities to facilitate the presentation such as vertical and/or horizontal scrollbars for navigation and toolbar buttons to determine whether a region will be viewable can be employed. For example, the user can interact with one or more of the components coupled and/or incorporated into matching component 102.

Users can also interact with regions to select and provide information via various devices such as a mouse, roller ball, keypad, keyboard, and/or voice activation, for example. Typically, mechanisms such as a push button or the enter key on the keyboard can be employed subsequent to entering the information in order to initiate, for example, a query. However, it is to be appreciated that the claimed subject matter is not so limited. For example, merely highlighting a checkbox can initiate information conveyance. In another example, a command line interface can be employed. For example, the command line interface can prompt (e.g., via text message on a display and/or an audio tone) the user for information via a text message. The user can then provide suitable information, such as alphanumeric input corresponding to an option provided in the interface prompt or an answer (e.g., verbal utterance) to a question posed in the prompt. It is to be appreciated that the command line interface can be employed in connection with a graphical user interface and/or application programming interface (API). In addition, the command line interface can be employed in connection with hardware (e.g., video cards) and/or displays (e.g., black-and-white, and EGA) with limited graphic support, and/or low bandwidth communication channels.

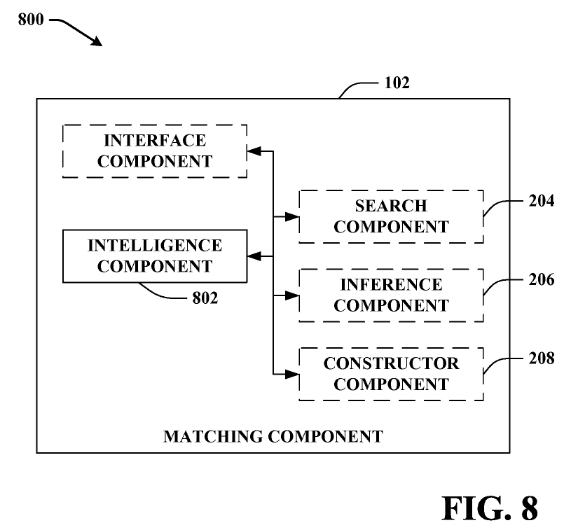

FIG. 8 depicts a system 800 that employs artificial intelligence to identify healthcare professionals appropriate to treat a disease in accordance with an aspect of the claimed subject matter. Accordingly, as illustrated, system 800 can include an intelligence component 802 that can employ a probabilistic based or statistical based approach, for example, in connection with making determinations or inferences. Inferences can be based in part upon explicit training of classifiers (not shown) before employing system 200, or implicit training based at least in part upon system feedback and/or users previous actions, commands, instructions, and the like during use of the system. Intelligence component 802 can employ any suitable scheme (e.g., neural networks, expert systems, Bayesian belief networks, support vector machines (SVMs), Hidden Markov Models (HMMs), fuzzy logic, data fusion, etc.) in accordance with implementing various automated aspects described herein. Intelligence component 802 can factor historical data, extrinsic data, context, data content, state of the user, and can compute cost of making an incorrect determination or inference versus benefit of making a correct determination or inference. Accordingly, a utility-based analysis can be employed with providing such information to other components or taking automated action. Ranking and confidence measures can also be calculated and employed in connection with such analysis.

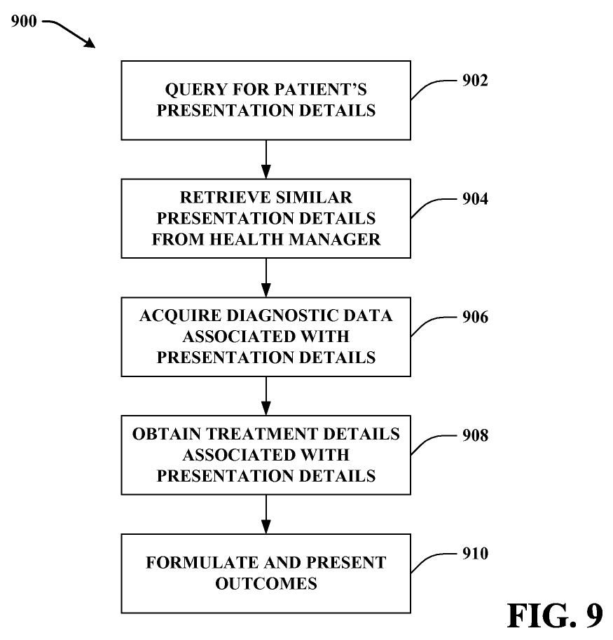

In view of the illustrative systems shown and described supra, methodologies that may be implemented in accordance with the disclosed subject matter will be better appreciated with reference to the flow charts of FIG. 9-11. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

FIG. 9 provides illustration of a machine implemented method 900 that identifies a healthcare professional to treat a disease based at least in part on a symptom presented by a patient and utilization of dynamically and contemporaneously constructed graphs (e.g., dependency graphs) and/or previously persisted but continuously adaptable networks (e.g., neural networks). Method 900 can commence at 902 where patient details can be solicited. For example, at 902 patients can be requested to input verification information (e.g., user name, password, social security number, provide biometric information—thumb print, iris scan, etc.) or symptoms of the disease that the patient is currently, or is perceived to be, suffering. At 904 patient details obtained at 902 can be employed to retrieve information from health manager 108 regarding diseases with similar symptomatologies (e.g., through utilization of health manager's 108 vertical search facilities) from other patient records that have been persisted or associated with health manager 108 and/or other medical providers (e.g., hospitals, clinics, insurance carriers, etc.) that have access and/or utilize health manager 108. At 906 diagnostic data can be acquired. As will be appreciated there can be many diagnoses given a set of presented symptoms. For example, if a patient presents with myalgia possible diagnoses can include trichinosis, typhoid fever, upper respiratory tract infection, toxic shock syndrome, chickungunya, or withdrawal syndromes associated with the sudden cessation of alcohol or barbiturates, for example. At 908 treatment details associated with the respective presentation details (e.g., patient symptoms), similar symptomologies (e.g., from health manager 108), and acquired diagnostic data can be utilized to obtain treatment details to remedy each of the illnesses associated with the acquired diagnostic data. At 910 outcomes can be formulated and presented. For example, at 910 a dependency graph can be constructed, as illustrated in FIG. 12, and utilized, wherein each of the presentation details, similar symptomologies, acquired diagnostic data, treatment details and treatment outcomes can be included in leaf nodes, intermediary nodes, and top-level nodes (e.g., top-level nodes indicating outcomes) such that the leaf nodes, intermediary nodes, and top-level nodes each are connected by one or more directed edges.

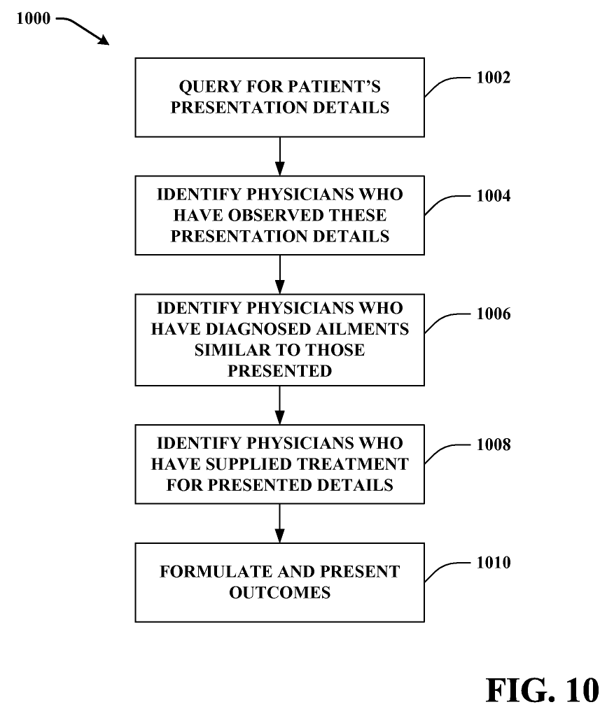

FIG. 10 depicts a method 1000 implemented on a machine that selects physicians or medical personnel who have treated a disease or ailment based at least in part on symptomatologies presented by patients in accordance with an aspect of the claimed subject matter. At 1002 patient details can be obtained, patient details can include information such as current symptoms that the patient is currently experiencing, any necessary authentication information to gain access to the facilities offered by health manager 106, and any search terms that the patient deems necessary for the search apparatus associated with either the claimed matter or affiliated with the functionality of health manager 106 to conduct a search for preferable medical personnel (e.g., medical professionals that the patient thinks would best suit him or her). For instance, if the patient is a woman she may wish to find only female medical personal to treat her ailment. At 1004 medical personnel who have observed or had experience with symptomologies similar to that of the presenting patient and/or who satisfy any other criteria that the patient may have supplied at 1002 can be identified. At 1006 medical personnel who have diagnosed (correctly or incorrectly) illnesses with symptomologies similar to those identified at 1004 can be identified and further at 1008 medical personnel who have supplied treatment or have recommended some curative strategies can be identified. At 1010 outcomes can be formulated and presented. Outcomes can be ascertained through use of directed acyclic graphs for example, wherein variables (e.g., presentation details, symptomatologies, medical personnel who have observed or treated ailments associated with the symptomatologies, and the like) can be included in nodes (e.g., leaf node, intermediary nodes, and top-level nodes) and the nodes connected via directed edges.

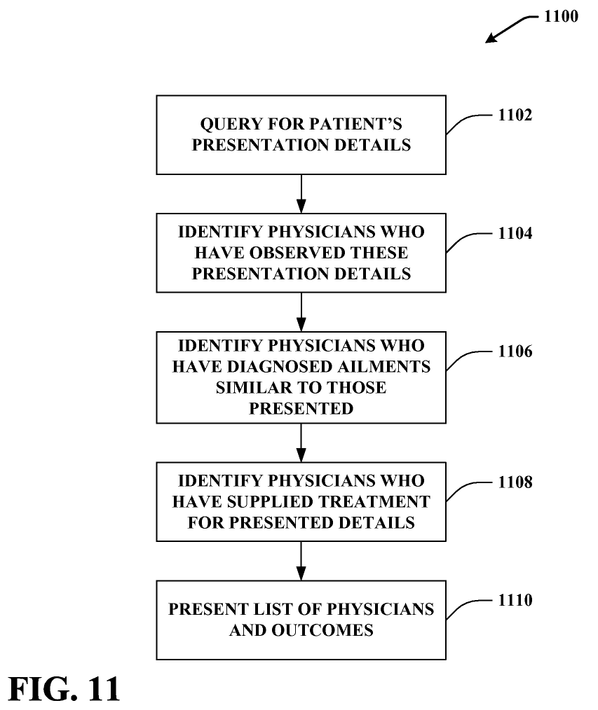

FIG. 11 illustrates a machine implemented method 1100 that identifies physicians or medical personnel who have treated a disease or ailment based at least in part on symptomologies presented by patients in accordance with an aspect of the claimed subject matter. Method 1100 can commence at 1102 where patient details can be solicited. At 1104 medical personnel who may have observed in the past symptomologies similar to that of the presenting patient and/or who satisfy any other criteria that the patient may have supplied at 1102 can be identified. At 1106 medical personnel who have diagnosed illnesses with symptomologies similar to those identified at 1104 can be identified and further at 1108 medical personnel who have supplied treatment or have recommended some curative strategies to treat (successfully or unsuccessfully) the disease indicated by the presented symptoms can be identified. At 1110 a report can be generated where medical personnel who have treated a disease indicated by the presented symptom can be listed. The list can typically be ranked in order of the most successful outcome, most efficacious treatment, or by fitness score determined from a dependency graph structure constructed by the claimed subject matter or derived from a dynamically generated or persisted artificial neural network.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

As used in this application, the terms “component” and “system” are intended to refer to a computer-related entity, either hardware, a combination of hardware and software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as in accordance with one or more aspects of the claimed subject matter as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

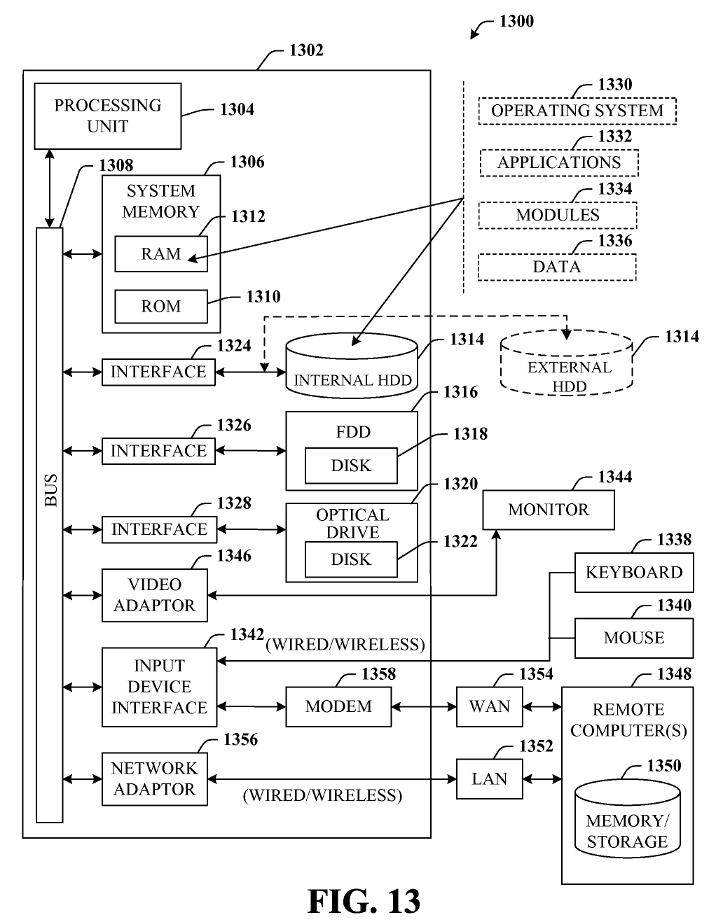

Referring now to FIG. 13, there is illustrated a block diagram of a computer operable to execute the disclosed system. In order to provide additional context for various aspects thereof, FIG. 13 and the following discussion are intended to provide a brief, general description of a suitable computing environment 1300 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 13, the illustrative environment 1300 for implementing various aspects includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures may also be employed as the processing unit 1304.

The system bus 1308 can be any of several types of bus structure that may further interconnect to a memory bus (with or without a memory controller), a peripheral bus, and a local bus using any of a variety of commercially available bus architectures. The system memory 1306 includes read-only memory (ROM) 1310 and random access memory (RAM) 1312. A basic input/output system (BIOS) is stored in a non-volatile memory 1310 such as ROM, EPROM, EEPROM, which BIOS contains the basic routines that help to transfer information between elements within the computer 1302, such as during start-up. The RAM 1312 can also include a high-speed RAM such as static RAM for caching data.

The computer 1302 further includes an internal hard disk drive (HDD) 1314 (e.g., EIDE, SATA), which internal hard disk drive 1314 may also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The hard disk drive 1314, magnetic disk drive 1316 and optical disk drive 1320 can be connected to the system bus 1308 by a hard disk drive interface 1324, a magnetic disk drive interface 1326 and an optical drive interface 1328, respectively. The interface 1324 for external drive implementations includes at least one or both of Universal Serial Bus (USB) and IEEE 1094 interface technologies. Other external drive connection technologies are within contemplation of the claimed subject matter.

The drives and their associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the illustrative operating environment, and further, that any such media may contain computer-executable instructions for performing the methods of the disclosed and claimed subject matter.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. It is to be appreciated that the claimed subject matter can be implemented with various commercially available operating systems or combinations of operating systems.

A user can enter commands and information into the computer 1302 through one or more wired/wireless input devices, e.g., a keyboard 1338 and a pointing device, such as a mouse 1340. Other input devices (not shown) may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE 1094 serial port, a game port, a USB port, an IR interface, etc.

A monitor 1344 or other type of display device is also connected to the system bus 1308 via an interface, such as a video adapter 1346. In addition to the monitor 1344, a computer typically includes other peripheral output devices (not shown), such as speakers, printers, etc.

The computer 1302 may operate in a networked environment using logical connections via wired and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wired/wireless connectivity to a local area network (LAN) 1352 and/or larger networks, e.g., a wide area network (WAN) 1354. Such LAN and WAN networking environments are commonplace in offices and companies, and facilitate enterprise-wide computer networks, such as intranets, all of which may connect to a global communications network, e.g., the Internet.

When used in a LAN networking environment, the computer 1302 is connected to the local network 1352 through a wired and/or wireless communication network interface or adapter 1356. The adaptor 1356 may facilitate wired or wireless communication to the LAN 1352, which may also include a wireless access point disposed thereon for communicating with the wireless adaptor 1356.

When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wired or wireless device, is connected to the system bus 1308 via the serial port interface 1342. In a networked environment, program modules depicted relative to the computer 1302, or portions thereof, can be stored in the remote memory/storage device 1350. It will be appreciated that the network connections shown are illustrative and other means of establishing a communications link between the computers can be used.

The computer 1302 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+Mbps in the 2.4 GHz band. Products can contain more than one band (e.g., dual band), so the networks can provide real-world performance similar to the basic 10 BaseT wired Ethernet networks used in many offices.

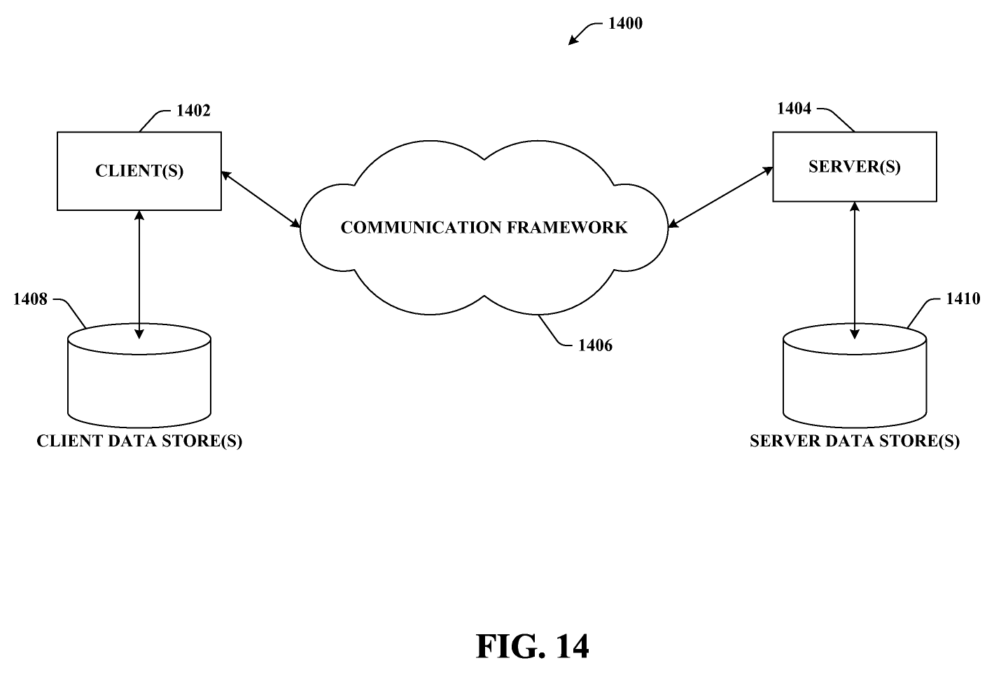

Referring now to FIG. 14, there is illustrated a schematic block diagram of an illustrative computing environment 1400 for processing the disclosed architecture in accordance with another aspect. The system 1400 includes one or more client(s) 1402. The client(s) 1402 can be hardware and/or software (e.g., threads, processes, computing devices). The client(s) 1402 can house cookie(s) and/or associated contextual information by employing the claimed subject matter, for example.

The system 1400 also includes one or more server(s) 1404. The server(s) 1404 can also be hardware and/or software (e.g., threads, processes, computing devices). The servers 1404 can house threads to perform transformations by employing the claimed subject matter, for example. One possible communication between a client 1402 and a server 1404 can be in the form of a data packet adapted to be transmitted between two or more computer processes. The data packet may include a cookie and/or associated contextual information, for example. The system 1400 includes a communication framework 1406 (e.g., a global communication network such as the Internet) that can be employed to facilitate communications between the client(s) 1402 and the server(s) 1404.

Communications can be facilitated via a wired (including optical fiber) and/or wireless technology. The client(s) 1402 are operatively connected to one or more client data store(s) 1408 that can be employed to store information local to the client(s) 1402 (e.g., cookie(s) and/or associated contextual information). Similarly, the server(s) 1404 are operatively connected to one or more server data store(s) 1410 that can be employed to store information local to the servers 1404.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A machine implemented system that identifies a healthcare professional appropriate to treat a disease, the system comprising:
a component that receives at least one of a patient symptom, a diagnosis, a treatment plan, or a treatment outcome related to the disease via an interface, the component employs one or more of the patient symptom, the diagnosis, the treatment plan, or the treatment outcome to at least one of construct a graph or utilize the graph to infer a score employed to identify the healthcare professional appropriate to treat the disease as presented by the patient and indicated by at least the symptom.

2. The system of claim 1, the healthcare professional associated with a competency attribute, the competency attribute determined by one or more of the treatment outcome associated with the healthcare professional, the diagnosis employed by the healthcare professional, the treatment plan proposed by the healthcare professional, an expertise attribute associated with the healthcare professional, or the treatment outcome associated with the healthcare professional, the expertise attribute based on a number of years the healthcare professional has practiced within a medical specialty associated with the disease.

3. The system of claim 1, the component determines the score employed to identify the healthcare professional appropriate to treat the disease presented by the patient based at least in part on a belief distribution.

4. The system of claim 1, the component searches a repository of healthcare records based at least in part on the patient symptom, the repository of healthcare records includes information related to the patient, the information related to the patient selectively masked off from general access.

5. The system of claim 1, the disease assigned a level of difficulty, the level of difficult determined by an average of the treatment outcome associated with other healthcare professionals.

6. The system of claim 1, the component associates the score with the healthcare professional and utilizes the score to provide a relative ranking of the healthcare professional with other healthcare professionals appropriate to treat the disease.

7. The system of claim 1, the component identifies the healthcare professional appropriate to treat the disease presented by the patient based at least in part on the healthcare professional's previous experience in treating the disease presented by the patient.

8. The system of claim 1, the score employed to identify the healthcare professional appropriate to treat the disease presented by the patient as indicated by at least the symptom one of elevated or diminished based at least in part on a successful treatment outcome or an unsuccessful treatment outcome.

9. The system of claim 1, the score utilized to select the healthcare professional appropriate to treat the disease presented by the patient as indicated by at least the symptom one of increased or decreased based at least in part on a time period that the treatment plan takes to cure the disease as presented by the patent and indicated by at least the symptom.

10. A machine implemented method that selects a medical professional able to treat a medical condition as presented by a patient, comprising:
obtaining a patient symptom, a diagnosis, a treatment plan, or a treatment outcome related to the disease;
constructing a directed graph utilizing the patient symptom, the diagnosis, the treatment plan, or the treatment outcome as nodes in the directed graph; and
utilizing a score from the directed graph to identify the medical professional able to treat the disease as presented by the patient.

11. The method of claim 10, further comprising determining a skill attribute associated with the medial professional, the skill attribute based at least in part on one of the diagnosis, the treatment plan, or the treatment outcome.

12. The method of claim 11, further comprising matching the medical professional with the medical condition presented by the patient based at least in part on the skill attribute.

13. The method of claim 10, further comprising initiating a directed vertical search of a health records repository utilizing at least one of the patient symptom, the diagnosis, the treatment plan, or the treatment outcome, the directed vertical search providing potential medical professionals proficient in treating the patient symptom.

14. The method of claim 10, the utilizing further comprising determining a relative ranking of the medical professional with other medical professionals competent to treat the patient symptom.

15. The method of claim 10, the utilizing further comprising at least one of increasing or diminishing the score based at least in part on a successful or unsuccessful treatment outcome.

16. The method of claim 10, the utilizing further comprising at least one of employing a duration associated with the treatment plan to enhance or reduce the score.

17. A system that identifies a medical professional able to treat a medical condition as presented by a patient, comprising:
means for receiving a patient symptom, a diagnosis, a treatment plan, or a treatment outcome related to the disease;
means for constructing a directed graph utilizing the patient symptom, the diagnosis, the treatment plan, or the treatment outcome as nodes in the directed graph; and
means for utilizing a score from the directed graph to identify the medical professional able to treat the disease as presented by the patient.

18. The system of claim 17, further comprising means for ascertaining the score based at least in part on a belief distribution.

19. The system of claim 17, the disease presented by the patient assigned a level of difficulty, the level of difficulty determined by an average of the treatment outcome associated with the disease as ascertained by a means for vertically searching a means for storing health records.

20. The system of claim 19, the level of difficult assigned the disease utilized by the means for utilizing the score to identify the medical professional able to treat the disease as presented by the patient.
